(19) United States
(12) Patent Application Publication
(10) Pub. No.: US 2024/0088686 A1
(43) Pub. Date: Mar. 14, 2024

(54) Unwinding Charger

(71) Applicant: Larry Brandon Kresta, Hempstead, TX (US)

(72) Inventor: Larry Brandon Kresta, Hempstead, TX (US)

(21) Appl. No.: 18/515,262

(22) Filed: Nov. 21, 2023

Related U.S. Application Data
(63) Continuation-in-part of application No. 17/321,439, filed on May 15, 2021.

(51) Int. Cl. H02J 7/00; H02J 50/00

(52) U.S. Cl. CPC H02J 7/0045; H02J 7/0044; H02J 50/005

(57) ABSTRACT

The Unwinding Charger is an apparatus for charging electric devices such as smart phones and tablets. The Unwinding Charger can be wound by a user and can unwind on its own to charge electric devices. The Unwinding Charger can be shaped like a smartphone. The Unwinding Charger includes a USB connection port and a wireless charging feature. The Unwinding Charger includes a body handle attached to a non-protruding axis shaft at the top of the charger which rotates to wind up the charger. The top body handle of the charger allows the user to wind the device more easily with a significant surface area for grip. The top body handle can be made in the likeness of its body counterpart for a streamlined and snag free structure. The Unwinding Charger can offer the new attribute of winding and forgetting to charge other devices on its own having been wound.

### CROSS-REFERENCE TO RELATED APPLICATIONS

Claims benefit of earlier filing date by reference of: U.S. Provisional Patent 63/171,665 filed Apr. 7, 2021 and U.S. patent Ser. No. 17/321,439 (patent pending) filed May 15, 2021.

### BACKGROUND OF THE INVENTION

The present invention relates to an apparatus which charges an electric device under its own power after having been wound. At this time there are a number of portable chargers for sale on the market. Specifically, there are three main types of portable chargers: winding chargers, battery to battery chargers, and solar chargers. Winding chargers are hand wound constantly to produce a charge. Winding chargers must be constantly held in the hands of the user and usually require two hands to operate the charger. The few winding chargers that do not require two hands to charge still take usage time and screen time away from the user while the device is charging due to the charger's constant attentive needs. Most winding chargers do not allow the user to use the device while it is being charged. Winding chargers often have a bulky winding handle. More often than not the handle is one that is too large for the charger to be carried around and considered portable. The user is required to recharge the charger by hand winding it, constantly. Although the winding charger does not need another power source to be recharged and can power itself; the user cannot wind and forget. This type of charger can charge under its own power but not after having been wound. Winding chargers cannot charge under its own power inside a pocket or purse. Another type of charger currently for sale on the market is a battery to battery style charger. This style of charger uses a battery to charge another device. The problem with this charger is it needs another power source to recharge. Since the battery to battery charger cannot power itself the user must seek out a power source to charge the charger. Lastly, there are solar powered chargers. Solar chargers use sunlight to charge another device. The manufacture of this type of charger is expensive. Solar chargers are not very effective at charging when used as a portable hand held charger, they require are large panel. Solar chargers are only effective outdoors where there is direct sunlight and cannot be used in poor weather conditions or when the sun goes down. In conclusion, other chargers currently for sale require constant winding from the user, a repeat recharge from another power source, or sunlight. No other charger currently for sale, charges under its own power after having been wound. Other options to charge devices exist. However, these options are considered conventional or non-portable. An example is using table-top and plug-in style chargers. Charging stations are used in public areas where people can gather around a table to charge their device. Wireless charging coils are now located inside the cabin of new vehicles.

### SUMMARY OF THE INVENTION

The Unwinding Charger is an apparatus for charging electric devices, such as smart phones and tablets, which unwinds to charge. The apparatus includes a USB connection port and a wireless charging feature wherein the apparatus charges other wired and wireless charge capable devices. At the top of the apparatus a winding handle is attached to a non-protruding axis shaft which rotates to wind the apparatus. The electric charge produced from the unwinding process charges electric devices such as smart phones and tablets. The Unwinding Charger pairs automatic watch components, alarm clock components and any other portable charger components to make the new invention charge another device under its own power after having been wound. The Unwinding Charger is a new wireless and USB charger which uses complex automatic watch components critical to the function of the new invention. The Unwinding Charger does not use an automatic watch or its structure but only an automatic watch's critical components. Some critical components shared by the Unwinding Charger and the charger's body handle include critical components from the automatic watch, the alarm clock, and any other portable chargers; these critical components are: charge storage apparatus, generator, coil assembly, a winding handle, various geared wheels and pinions and a housing. The Unwinding Charger may require two hands and may be tough to wind; much like an alarm clock. The structure of the device is made to grip and turn. The size of the body handle and body allow for more mainspring resistance. The charge is created by turning the body handle at the top of the device to wind the mainspring. The user will turn the handle to wind the mainspring. The wound mainspring is meshed and aligned to then turn an array of geared wheels. The array of geared wheels can be called a gear assembly and is aligned and meshed to a generator. The generator is turned by the geared wheels and gear assembly to produce an electric charge. The generator powers up the charge storage apparatus which then send the electric charge to a wireless coil assembly. The USB port delivers an electric charge when a device is plugged in. The Unwinding Charger can be shaped like a smart phone. It is mostly made like any other portable charger except it includes an internal winding apparatus and an internal unwinding apparatus which is most similar to an automatic watch or wind up alarm clock. The invention made is an apparatus that is woundable and unwinds to charge electric devices such as smartphones and tablets on its own having been wound.

### BRIEF DESCRIPTION OF DRAWINGS

FIG. 1 is a drawing which shows an example of an Unwinding Charger. FIG. 1 shows the example of the charger with a single USB port (106) and wireless charge capabilities indicated by the wireless logo. FIG. 1 shows an example of a body handle (99).

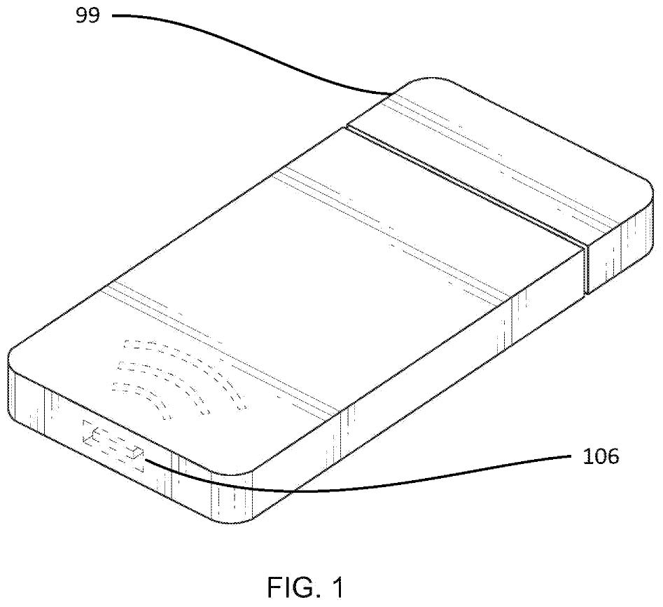

FIG. 2 is a drawing which shows an example of a layer of an Unwinding Charger. FIG. 2 shows a gear pinion (100), and housing (101), an example of a generator (102), an example of an internal unwinding apparatus (103), an example of a charge storage apparatus (104), a charge controller (105), and a USB port (106).

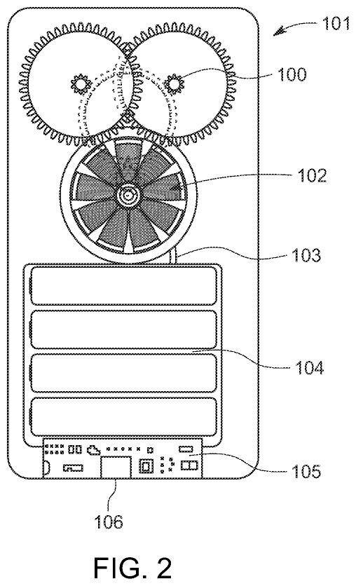

FIG. 3 is a drawing which shows an example of a layer of an Unwinding Charger. FIG. 3 shows a geared wheel (107), a gear assembly (108), a wireless coil (109), body (110), winding assembly (111), and internal winding apparatus (112).

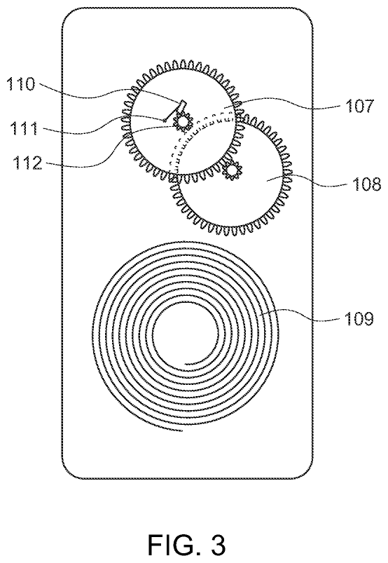

FIG. 4 is a drawing which shows an example of a layer of an Unwinding Charger. FIG. 4 shows a mainspring (113) and winding assembly (114).

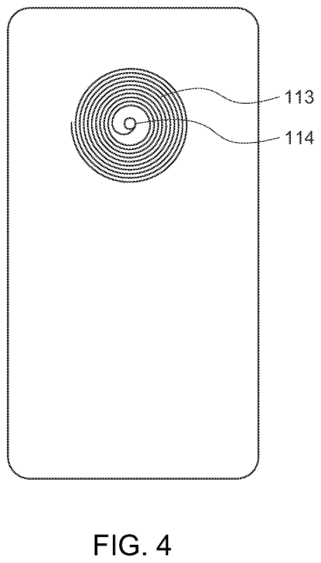

### DETAILED DESCRIPTION OF THE INVENTION

The charger's detailed description is disclosed herein.

In specific embodiments, the said apparatus comprises: a body handle (99) connected at the top of the apparatus by means of a rotating and non-protruding axis shaft. The body handle (99) is a part which is used by the Unwinding Charger. The body handle (99) is configured to allow the Unwinding Charger to wind and unwind while paired to another handheld device. A body handle (99), as used herein, can be described as a winding handle that is made in the likeness of its counterpart body and can thus be called a body handle (99). A body handle (99), as used herein, can refer to a type of winding handle which can be folded and unfolded, can be deployable, is used to turn or wind a charging device as any other portable charger uses a winding handle. A body handle (99), as used herein, can be made in the likeness of a winding handle used by an alarm clock, an automatic watch or any other portable charger. When the body handle (99) is rotated by the user the body handle (99) coils the mainspring (113). The body handle (99) can be shaped like its body to allow the charger to pair more easily with another device. The body handle (99) can enable the charger to fit into a pocket and a case or cradle easily. The body handle (99) can enable the charger to work well alongside other devices and pair to another device in a snag free manor. The non-protruding axis shaft is a part which is used by the Unwinding Charger. A non-protruding axis shaft, as used herein, refers to a shaft that is center fixed to the winding handle and connects the handle to other charger components. The non-protruding axis shaft is center fixed to add strength, reliability, and better alignment to the body handle (99) and other joined components. The body handle (99) rotates the non-protruding axis shaft which in turn rotates the internal winding apparatus (112).

In specific embodiments, the said apparatus comprises: an internal winding apparatus (112). The internal winding apparatus (112) is a part which is used by the Unwinding Charger. The internal winding apparatus (112) includes structural features to wind like an automatic watch or an alarm clock and/or any other portable charger. The internal winding apparatus (112) can include automatic watch components, alarm clock components and other portable charger components. The user rotates the non-protruding axis shaft which is connected to the mainspring (113) and as a result the mainspring (113) is wound when rotated. The internal winding apparatus (112) is geared and meshed to the internal unwinding apparatus (103) by a connected gear assembly (108). Together these critical components form the winding assembly (111).

In specific embodiments, the said apparatus comprises: an internal unwinding apparatus (103). The internal unwinding apparatus (103) is a part which is used by the Unwinding Charger. The internal unwinding apparatus (103) can include structural features to unwind like an automatic watch or an alarm clock. The internal unwinding apparatus (103) can include automatic watch components and alarm clock components. The internal unwinding apparatus includes a mainspring (113). The internal unwinding apparatus (103) and the internal winding apparatus (112) can share a mainspring (113). As the mainspring (113) is wound by the internal winding apparatus (112) tension causes the mainspring (113) to unwind. When the mainspring (113) unwinds it turns geared wheels (107). The geared wheels (107) include an attached gear pinion (100). The gear pinion (100) is geared and meshed to an array of geared wheels (107) with their attached gear pinions (100). The geared and meshed geared wheels (107) and their attached gear pinion (100) form a gear assembly (108). The gearing and attachment of geared wheels (107) and gear pinions (100) can be made in the likeness of an automatic watch, an alarm clock, and/or any other portable charger. The gear assembly (108) turns along with, and is geared to, the mainspring (113). The geared assembly (108) then turns a generator (102). The internal unwinding apparatus (103) is geared and meshed to the generator (102) by gear assembly (108).

In specific embodiments, the said apparatus comprises: a generator (102). The generator (102) turns to produce electricity. The generator (102) which is used by the Unwinding Charger can be made and used in the likeness of a generator (102) which is used by any other portable charger. The generator (102) can be connected in the likeness of any other portable charger to the charge storage apparatus (104). The generator (102) can charge a charge storage apparatus (104) in the likeness of any other portable charger.

In specific embodiments, the said apparatus comprises: a charge storage apparatus (104). A charge storage apparatus (104) as used herein can be described as an apparatus used to hold and distribute an electric charge. A charge storage apparatus (104) can be comprised of or made and used in the likeness of a capacitor or battery. The charge storage apparatus (104) can hold an electric charge and can distribute an electric charge to a paired device. The charge storage apparatus (104) can be made and used by the Unwinding Charger in the likeness of a charge storage apparatus (104) which is used by any other portable charger. The electric charge can be distributed from the charge storage apparatus (104) to a paired or connected device in the likeness of any other portable charger. The charge storage apparatus (104) can send an electric charge to a wireless coil (109) and/or a USB port (106) in the likeness of any other portable charger.

In specific embodiments, the said apparatus comprises: a charge controller (105). The charge controller (105) can allow the charger to charge electric devices on its own power having been wound by controlling and distributing the electric charge to another device. The charge controller (105) includes features to control and distribute a charge to another electric device. The charge controller (105) as used herein can be defined as a group of controls which control and distribute a charge to another device. The charge controller (105) can be made in the likeness of a charge controller (105) used by any other portable charger.

In specific embodiments, the said apparatus comprises: a wireless charge assembly. The wireless charge assembly includes a wireless coil (109). The wireless charge assembly can include features to wirelessly receive an electric charge and to wirelessly distribute an electric charge to another electric device in the likeness of any other portable charger. The wireless charge assembly can include components used by any other portable chargers.

In specific embodiments, the said apparatus comprises: a USB charge assembly. The USB charge assembly includes a USB port (106). The USB charge assembly can include features to receive an electric charge and distribute an electric charge to another electric device in the likeness of any other portable charger. The USB charge assembly can include components used by any other portable chargers.

In specific embodiments, the said apparatus comprises: a housing (101). The housing (101) can be described as the overall structure of the Unwinding Charger's body (110). The housing (101) holds critical components inside and can aid in the aligning and meshing of the components.

The invention made is an apparatus that is woundable and unwinds to charge electric devices such as smartphones and tablets on its own power after having been wound. The Unwinding Charger can be charged and can deliver power to other compatible electric devices. The Unwinding Charger can be shaped like a smart phone. The charger is mostly made like any other portable charger except it includes components used in an automatic watch and/or an alarm clock to unwind to charge. The unwinding charger uses alarm clock and automatic watch components to turn a generator (102). The generator (102) is turned to produce electricity which charges the charge storage apparatus (104). The charge storage apparatus (104) charges other devices much like the way any other portable charger charges a device. In conclusion, the Unwinding Charger charges other devices like any other portable charger except the Unwinding Charger improves other portable chargers with the new inventive step of winding and unwinding in the likeness of an automatic watch or winding alarm clock by use of gears and attached pinions to charge other devices.

1. An apparatus, comprising:
a housing;
a winding body handle held in said housing for turning and winding the charger;
a non-protruding center fixed axis shaft for winding a mainspring when rotated;
an internal winding apparatus held in said housing for winding the charger;
an internal unwinding apparatus held in said housing for unwinding the charger;
a generator held in said housing for producing an electric charge;
a charge storage apparatus held in said housing for storing an electric charge and distributing an electric charge to another electric device;
a charge controller held in said housing for controlling an electric charge;
a wireless charge delivery assembly held in said housing for receiving and delivering a wireless electric charge to another electric device;
a USB charge delivery assembly held in said housing for receiving and delivering a wired electric charge to another electric device.

2. The apparatus of claim 1, wherein the housing its structure is configured to accommodate the charging of another handheld device inside a pocket when paired and wherein is configured so that the charger can be wound while paired with another handheld device.

3. The apparatus of claim 1, wherein a winding body handle is attached to a non-protruding axis shaft; is configured so that the non-protruding axis shaft is made non-protruding; its structure is configured to accommodate the charging of another handheld device inside a pocket when paired and wherein is configured to be wound while paired with another handheld device.

4. The apparatus of claim 1, wherein a non-protruding axis shaft is configured to join a winding handle to an internal winding apparatus; is center fixed; is held in place by said housing; is described as a center fixed non-protruding shaft that joins a winding handle to an internal winding apparatus and wherein its structure is configured to accommodate the charging of another handheld device inside a pocket when paired.

5. The apparatus of claim 1, wherein an internal winding apparatus is described as an apparatus which winds inside the said housing; is comprised of a mainspring inside the said housing; is joined to said non-protruding axis shaft; is configured for said mainspring to be turned by said non-protruding axis shaft and wherein is configured for said mainspring to be wound by said non-protruding axis shaft.

6. The apparatus of claim 1, wherein an internal unwinding apparatus is described as an apparatus which unwinds inside the said housing; is comprised of a mainspring and a geared wheel with an attached gear pinion inside the said housing; is configured for said mainspring to unwind; is configured for said mainspring to turn said geared wheel and attached gear pinion inside said housing; is configured for said mainspring to be joined to said geared wheel and wherein said geared wheel is attached to said gear pinion.

7. The apparatus of claim 1, wherein said generator is configured to turn to produce an electric charge inside said housing; is held in place by said housing and wherein is configured to be turned by said mainspring inside said housing.

8. The apparatus of claim 1, wherein said charge storage apparatus is configured to hold an electric charge inside said housing and wherein is configured to release an electric charge inside said housing and wherein is held in place by said housing.

9. The apparatus of claim 1, wherein the charge controller is configured to control and an electric charge inside said housing and wherein is held in place by said housing.

10. The apparatus of claim 1, wherein a wireless charge delivery assembly is configured to include a wireless charging coil; is configured to receive an electric charge and wherein is configured to deliver an electric charge.

11. The apparatus of claim 1, wherein a USB charge delivery assembly is configured to include a USB port; is configured to receive an electric charge and wherein is configured to deliver an electric charge.
